(19) United States
(12) Patent Application Publication
(10) Pub. No.: US 2006/0089159 A1
(43) Pub. Date: Apr. 27, 2006

(54) Open location management device

(76) Inventor: Dong Liu, Beijing (CN)

Correspondence Address: LOUIS PAUL HERZBERG, 3 CLOVERDALE LANE, MONSEY, NY, 10952, US

(21) Appl. No.: 10/513,722

(22) PCT Filed: May 9, 2003
(86) PCT No.: PCT/GB03/19868

§ 371 Date: Nov. 30, 2005

(30) Foreign Application Priority Data
May 15, 2002 (CN) 02119299.5

(51) Int. Cl. H04Q 7/20

(52) U.S. Cl. 455/456.5; 455/456.1

(57) ABSTRACT

The invention provides an open location management device, an open location management system and an open location management method, in which an open location management device receives a user location management request from a location information requester, and selects one location management provider from one or more location management providers to provide the user location information for the location information requestor. A unique user ID is assigned to each user in the system. By employing the invention, the location information requester can leverage the user location information provided by external location information providers, such that the burden of performing the location management of the location information requestor can be reduced.

### FIELD OF THE INVENTION

The present invention relates to a communication network, and in particular, relates to an open location management device, an open location management system and method, in which location management on a communication terminal in a communication network is performed by using the location information provided from a location information requestor outside the communication network.

### BACKGROUND OF THE INVENTION

It is important for a communication network, e.g., a mobile network, to govern the current location of a mobile station, in order to provide prompt service for the mobile station. In this way, the mobile network can rapidly determine the location of the mobile station, set up the connection and transfer information to/from the mobile station, when there is information such as call or short message to be sent to the mobile station or when the mobile station sends out information. A mobile station may be moving while it is engaged in a communication or in an idle state. To ensure the continuity of an already initiated connection, the mobile station is handover between the access points. When a mobile station is not engaged in a communication, the network must be able to determine its current cell in order to setup and route an incoming connection.

Location management in current mobile networks such as GSM is carried out by two basic operations: paging and location updating.

FIG. 1 shows the paging and the location updating procedure implemented in a GSM network. Similar approaches are also employed in other mobile networks. With the conventional location management strategy, the network coverage area is divided into smaller call cluster called Location Areas (LA). A location area is the granularity at which the network keeps track of the locations of the mobile stations, i.e., a location area is that group of cells in which the mobile station must be able to be located. When a mobile station moves from one location to another, a location updating procedure is triggered and the mobile station informs the network about this change of location area.

To enable the mobile station to detect a change of location area, the base stations periodically broadcast the identifiers of the location they belong to. On the other side, the mobile station ‘listens’ to the location area identifier (LAI) currently being broadcasted and compares it to a recorded LAI (the LAI where it was last located). If the two LAIs are identical, the mobile station does not do any work. However, if the two lAIs are different, the mobile station interprets this as a change of location area, a location updating procedure is then triggered and the old LAI is replaced with the new one. At the same time, the mobile station notifies the mobile network the change of its LAI. The mobile network processes the updating procedure on its side in response to receiving the notification, so as to promptly manage the current location of the mobile station.

In the conventional location updating management mechanism, a base station continuously broadcasts the LAI of the location area it belongs to, while a mobile station continuously ‘listens’ to the broadcasted LAI, and compares it to the registered one. If the two lAIs are different, the mobile station notifies the mobile network the change of its LAI. The mobile network processes the updating procedure on its side, in response to receiving the notification. Then the problem is raised that the overhead of the network increases very much and the network resource is wasted. Furthermore, the power of the mobile station is consumed very quickly because of continuously transmitting signals from the mobile station to the mobile network.

In practice, two situations usually exist, one is that different mobile network service providers set up their own base stations in the same area and use their own base stations to perform the location management on the mobile stations belonging to them, respectively; the other one is that the mobile network A cannot make the location management on its users moved to the area not covered by the network A, even though the mobile network B is able to perform the location management in this area. The disadvantage in the former is that the overall cost will increase because of the overlappingly building up the base stations in one area, while the disadvantage in the latter is that the already existing resources capable of making the location management cannot be sufficiently used.

In addition, in the conventional technique for performing the location management in the mobile network, the mobile network performs the location management in a loop manner, since the mobile stations and the mobile network continuously exchange location information. With more and more communication networks rushing out, many of them have the capability of tracking the users' locations within their own network scopes.

In fact, many information systems are now able to track the location of the terminals belonging to them. For example, IBM has developed a system for tracking the location of its staff timely, in which the system may track and locate the positions of the persons working in the IBM building through, for example, determining which lab one of its staff now stays by checking the timecard system of the building; determining whether or not the person may receive calls by checking the status of the Thinkpad used by this person. The system even could know where and what the person is now in and doing by checking the work logs or blue pages stored in the system by this person. If the communication network could take the advantage of the location management function in the building to govern the location management of its users who are justly working in this building, the burden of the network will be reduced much. In this case, the mobile network could get the latest location information of the mobile stations used by the users from the real-time tracking system in the building, without continuously exchanging location information with the mobile stations located in the building.

There are various of systems capable of providing location information. For example, in the networklized subway system, the system could hold the location information of a mobile station of a user by checking the location changing information of the train taken by the user. The burden of the mobile network will greatly reduce if it could get the location information of the mobile station through the subway system.

### DISCLOSURE OF THE INVENTION

In accordance with the present invention there is now provided an open location management device, an open location management system and method for providing the location information of an user in a communication network from a location information requestor outside the communication network, so as to efficiently reduce the overhead of the network for performing the location management.

Viewed from another aspect the present invention provides an open location management device, an open location management system and method for providing the location information of an user in a communication network from a location information requestor outside the communication network, so that the communication network could govern the location of the user even when the user moves into an area not covered by the network.

Viewed from another aspect the present invention provides an open location management device, which may be provided by a separate third party or be provided to each communication network as an attachment.

Viewed from another aspect the present invention provides an open location management device, an open location management system and method capable of selecting an appropriate location information provider based on certain selection policy.

Viewed from another aspect the present invention provides an open location management device, characterized in that: comprising a location information provider list for recording the IDs of one or more location information providers capable of performing location management; a location information provider selecting means for selecting one of the location information providers in the location information provider list to provide the location information of a user for the location information requestor, in response to a request for performing location management with respect to the user from a location information requestor; a location information notifying means for notifying the location information requestor the location information of the user provided by the selected location information provider in the location information provider list.

Preferably the present invention provides an open location management device comprising said location information provider selecting means selects the location information provider based on specific selection policy.

Preferably the present invention provides an open location management device, comprising a unique user ID is assigned to individual user of said location information requester and said location information provider.

Preferably the present invention provides an open location management device, comprising a location management table for storing the correspondence relationship between the user ID of the user and the ID of the location information provider selected for the user.

Preferably the present invention provides an open location management device, comprising said open location management device is a part of said location information requestor.

Preferably the present invention provides an open location management device, characterized in that: said one or more location information providers each having: location information answering means for receiving a location information inquiry request including said user ID contained in said location management request, and for returning the result of the location information inquiry to said open location management device; a current user list, connected to said location information answering means, for recording the terminal IDs of the users being registered in said location provider and the user IDs of the users, respectively; location determining means, for determining the location information of the user having the user ID provided by said location information answering means, and for sending the location information back to said

location information answering means.

Viewed from another aspect the present invention provides for an open location management system, comprising one or more location information requestors and one or more location information providers, characterized in that: the system further comprising an open location management device for providing the location information of a user provided by one of the one or more location information providers for the one of the one or more location information requestors, in response to a request for performing location management with respect to the user from one of the one or more location information requestors, the open location management device further having a location information provider list for recording the IDs of the one or more location information providers capable of performing location management, location information provider selecting means for selecting one of the location information providers in the location information provider list to provide the location information of a user for the location information requester, in response to a request for performing location management with respect to the user from one of the location information requestors; location information notifying means for notifying the location information requester the location information of the user provided by the selected location information provider in the location information provider list.

Preferably the present invention provides for an open management management system characterized in that; said one or more location information requesters each having user number storing means for storing the correspondence relationship between the terminal ID of each user of the location information requestor and the unique user ID assigned to him/her in the system; location information inquiry means, for sending to said open location management device a location management request including the user ID of a user.

Preferably the present invention provides for an open location management system according characterized in that: said one or more location information providers each having: location information answering means for receiving a location information inquiry request including said user ID contained in said location management request, and for returning the result of the location information inquiry to said open location management device; a current user list, connected to said location information answering means, for recording the terminal IDs of the users being registered in said location provider and the user IDs of the users; location determining means, for determining the location information of the user having the user ID provided by said location information answering means, and for sending the location information back to said location information answering means.

Preferably the present invention provides an open location management system, characterized in that: said location information provider selecting means selects the location information provider based on specific selection policy.

Preferably the present invention provides an open location management system characterized in that: said open location management device further comprising a location management table for storing the correspondence relationship between the user ID of the user and the ID of the location information provider selected for the user.

Viewed from another aspect the present invention provides an open location management method, characterized in that, comprising the steps of: receiving a user location management request including a user ID from a location information requestor; sending to one or more location information providers a location information inquiry request including the user ID; receiving the returned location information from the one or more location information providers; selecting one location information returned from one of the one or more location information providers; returning the selected location information to the location information requester.

Preferably the present invention provides for an open location management method characterized in that: further comprising the steps of: said one or more location information providers each receiving said location information inquiry request including said user ID; said one or more location information providers each detecting if said user ID being registered in the provider; said one or more location information providers each determining the location information corresponding to said user ID and returning the same, when it detects that said user ID is registered in the provider.

Preferably the present invention provides an open location management method characterized in that: said user ID is unique to each user.

Preferably the present invention provides an open location management method characterized in that: said selecting step further comprising the step of selecting the location information provider based on specific selection policy.

Preferably the present invention provides an open location management method characterized in that: said selecting step further comprising the step of storing the correspondence relationship between the user ID of the user and the ID of the location information provider selected for the user.

### BRIEF DESCRIPTION OF THE DRAWINGS

The invention will now be described by way of example only, with reference to the accompanying drawings, in which:

FIG. 1 is a diagram showing a location management process in a conventional way;

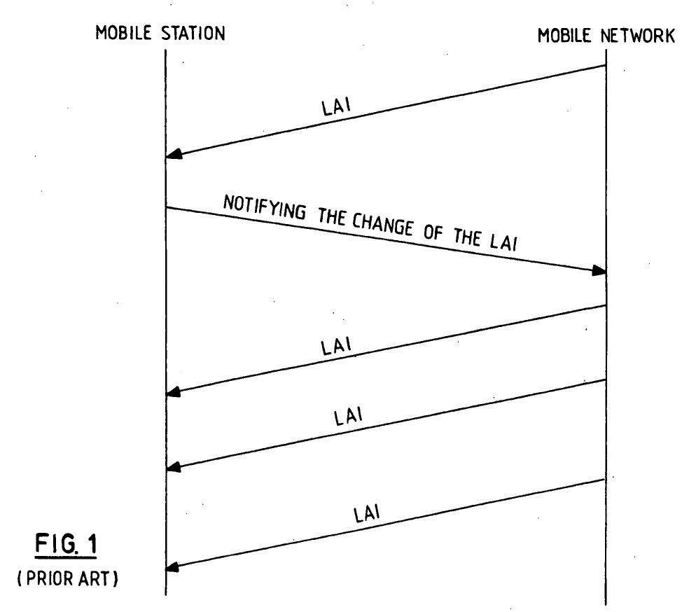

FIG. 2 is a conceptual block diagram of the open location management system according to the invention;

FIG. 3 is a functional block diagram of the open location management system according to the first embodiment of the invention;

FIG. 4 is a flowchart of the process of the open location management device according to the first embodiment of the invention;

FIG. 5 is a flowchart processed in the location information provider according to the first embodiment of the invention;

FIG. 6 is a functional block diagram of the open location management system according to the second embodiment of the invention; and

FIG. 7 is a flowchart of the process of the open location management device according to the third embodiment of the invention.

### DETAILED DESCRIPTION OF THE PREFERRED EMBODIMENTS OF THE INVENTION

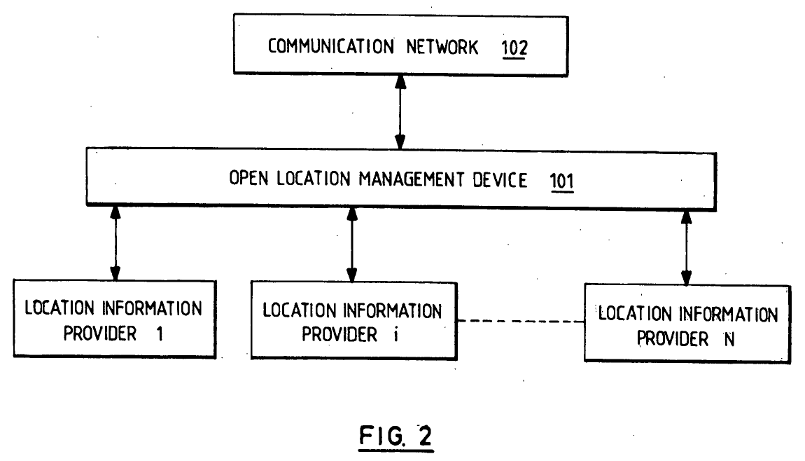

FIG. 2 is a functional block diagram of the open location management system according to the invention. As shown in FIG. 2, an open location management device 101 receives a location management request with respect to a user from a communication network 102. The open location management device 101 selects one location information provider i currently making the location management on any of the other terminals used by the user, from a plurality of location information providers 1 to N. The open location management device 101 then notifies the communication network 102 the location information of the other terminal held by the location information provider i as the location information of the user.

In this way, the communication network 102 may commit the job of governing the location management on certain terminal belonging to itself held by a user to the open location management device 101, which determines an appropriate location information provider for the user to provide the location information of the user for the communication network 102. As a result, the running burden of the communication network 102 may be reduced and the communication network may sufficiently take the advantage of the external locating resource to make the location management on terminals.

The structure of the open location management system according to the concept shown in FIG. 2 will now be described in detailed.

The open location management system according to the invention assumes that the system assigns a unique identification number (hereinafter referred to be a user ID) to each user enjoying communication through various terminals. A user identifying process is performed through using the user ID among three parties, i.e., the communication network, the open location management device and the individual location information provider. For example, different kinds of communication numbers belonging to one user correspond to one unique user ID, these communication numbers, for example, being the mobile phone number of the mobile phone owned by the user; the IP address of the computer held by the user; and the paging number of the pager owned by the user. The invention acts by referring the user as an object when addressing the location of the user. And then the storages are included in the three sides, especially in the communication network and the location information provider, respectively, in order to hold the corresponding relationship between the internal identification numbers of the user terminals in the network and the unique user IDs respectively.

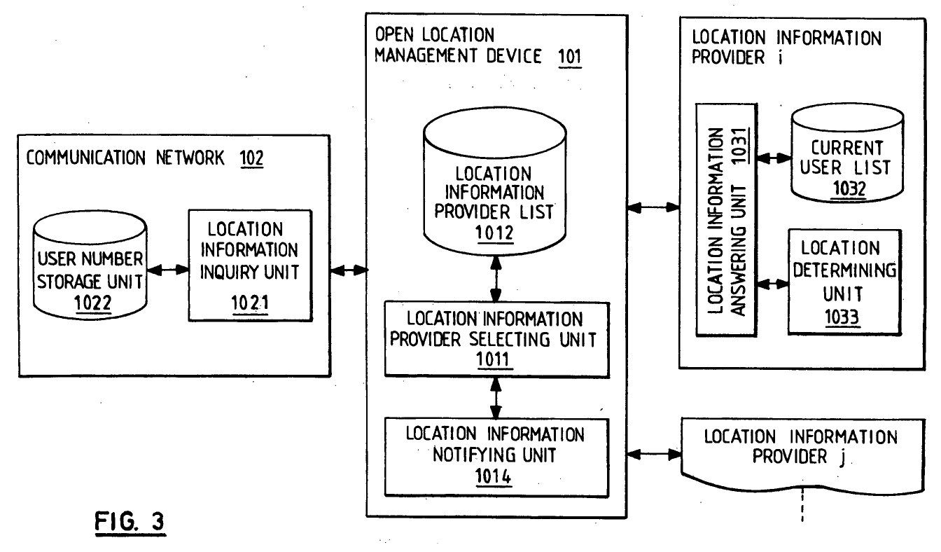

FIG. 3 is a functional block diagram of the open location management system according to the first embodiment of the invention.

As shown in FIG. 3, the communication network 102 includes a user number storage unit 1022, which stores the corresponding relationship between the user IDs assigned to all the users in the communication network 102 and the internal user identification numbers in the communication network 102, respectively. the user IDs are assigned by an unshown user ID assignment unit in the open location management device 101.

The communication network 102 further includes a location information inquiry unit 1021, which sends a location management request to the open location management device 101, the location management request including the user ID of a user and a request for asking the open location management device 101 to provide it the location information of the user.

The open location management device 101 includes a location information provider selecting unit 1011, a location information provider list 1012 and a location information notifying unit 1014.

The location information provider selecting unit 1011 sends a location inquiry request to the location information providers in the location information provider list 1012 and selects one of the location information providers sending back the location information, in response to a request for performing location management with respect to the user from the communication network 102.

The contents stored in the location information provider list 1012 may include the IDs of the location information providers, and the performance thereof such as the coverage, the positing precise and the cost time for positing.

The location information notifying unit 1014 notifies the communication network 102 the location information returned by the selected location information provider. The location management operation procedure according to the first embodiment will now be described in details.

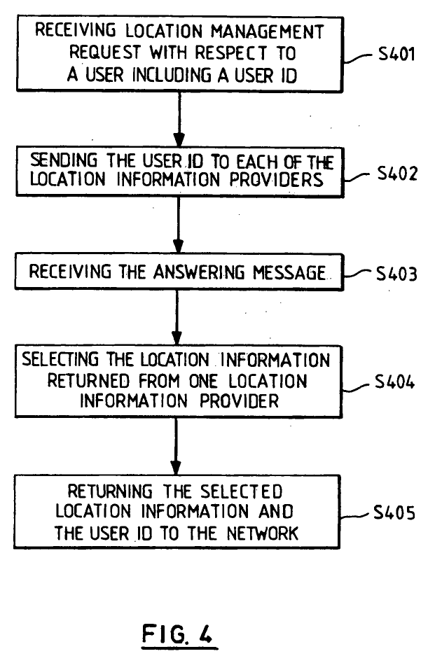

As shown in FIG. 4, at step S401, the location information provider selecting unit 1011 receives a location management request with respect to a user including a user ID, from the location information inquiry unit 1021 in the communication network 102. At step S402, the location information provider selecting unit 1011 sends a location inquiry request to the location information providers in the location information provider list 1012, the location inquiry request requesting for the location information of the user having the user ID. At step S403, the location information provider selecting unit 1011 receives the location information answering message from the location information providers. At step S404, the location information provider selecting unit 1011 selects one location information returned by one location information provider, for example, the location information provider first returning the location information. At step S405, the location information notifying unit 1014 returns the user ID, as well as the location information, to the communication network 102.

In addition, when the location information provider selecting unit 1011 determines there is no location information provider capable of providing the location information of the user based on certain trigger, it will return a message presenting that it could not provide the location management service to the communication network 102. The trigger, for example, is when all the location information providers return rejection message, or when the location information provider selecting unit 1001 fails to receive any message from any of the location information providers after certain time.

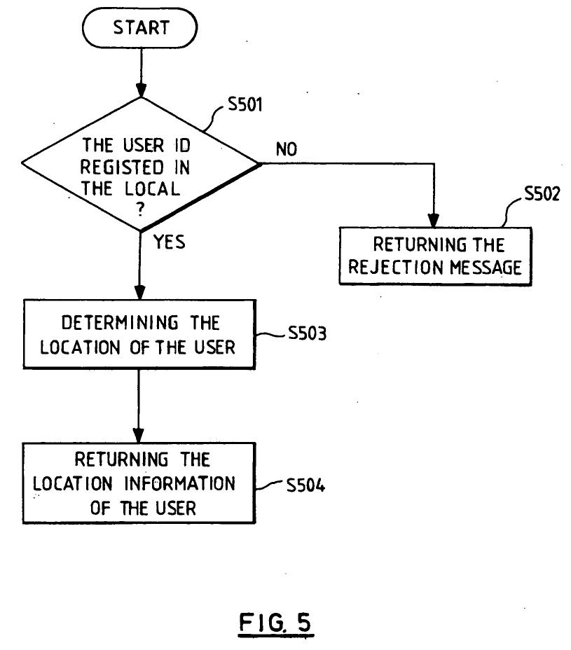

FIG. 5 is a flowchart showing the process in the location information provider according to the first embodiment of the invention. At step S501, the location information answering unit 1031 in each of the location information providers receives the location information inquiry request, detects whether or not the user ID included in the location information inquiry request exists in the current user list 1032, and if there is no corresponding user ID, at step S502, the location information answering unit 1031 returns to the location information provider selecting unit 1011 a rejection message presenting that the user is not in its service scope. And if there exists the corresponding user ID, it means that the user is now in the service scope of the location information provider, then at step S503, the location determining unit 1033 determines the location information of the user having the user ID. At step S504, the location information answering unit 1031 returns its own identification number, as well as the current location information determined by the location determining unit 1033 and the user ID, to the location information provider selecting unit 1011.

According to the first embodiment of the invention, the location information of an user in a communication network is provided by an external location information requestor outside the communication network, in response to a location management request from the communication network, so that the overhead of the network is greatly reduced and the external resource is efficiently leveraged, as far as the communication network is concerned.

The second embodiment is similar to the first embodiment except that it adds a location management table 1013. The same components are assigned the same reference numerals as in the first embodiment and the description thereof is omitted.

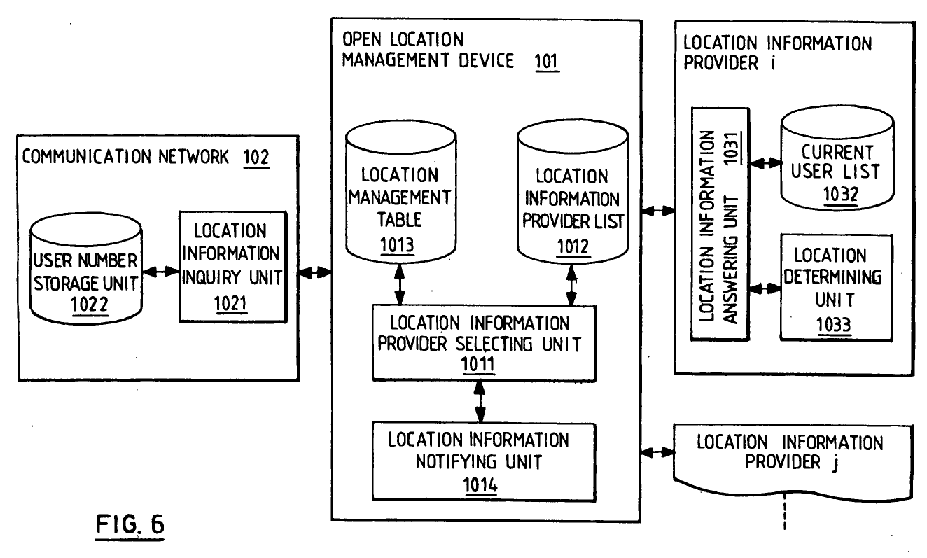

FIG. 6 is a functional block diagram of the open location management system according to the second embodiment of the invention.

In the first embodiment, the location information provider selecting unit 1011 executes a selecting operation whenever there comes a location management request from the communication network 102, in order to select a location information provider for the communication network 102. The second embodiment further includes a location management table 1013 for storing the correspondence relationship between the user IDs of the users and the IDs of the location information provider selected for the users by the location information provider selecting unit 1011 respectively.

The location information provider selecting unit 1011 stores the identification information of the selected location information providers into the location management table 1013. When the communication network 102 sends again a location management request, the location information provider selecting unit 1011 firstly detects the location management table 1013 to check whether or not there is a location information provider corresponding to the user requested by the communication network 102. And if there is a provider, the location information provider selecting unit 1011 sends the location information inquiry request to the location information provider directly.

According to the second embodiment of the invention, the location information provider information selected for a user is stored in the open location management device, and the selected location information provider is inquired directly when a locating request with respect to the user is required the next time, so that the performance of the open location management device is optimized and the response of the system is raised.

In the third embodiment, the location information provider selecting unit 1011 selects a location information provider based on some specific selection policy.

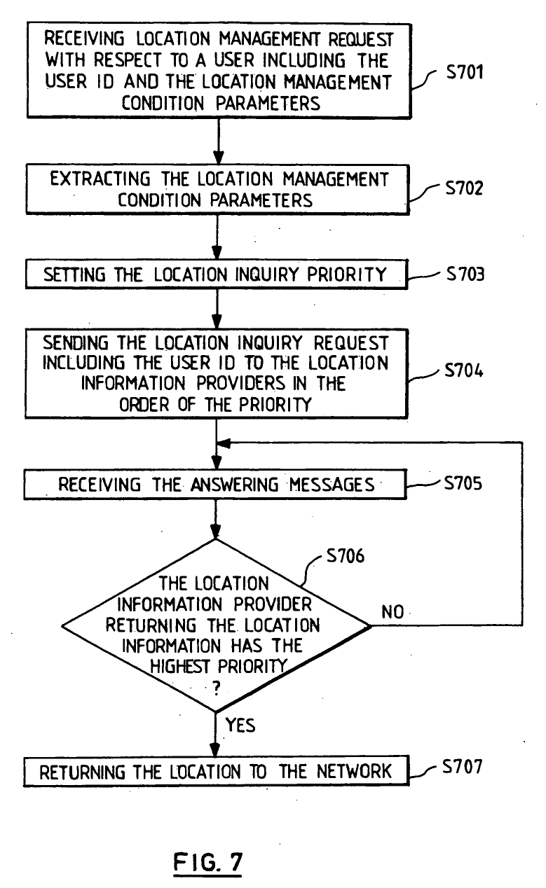

FIG. 7 is a flowchart of performing the location management based on the selection policy parameters sent from the communication network according to the open location management system.

Firstly, at step S701, the location information inquiry unit 1021 in the communication network 102 sends the location management request with respect to a user to the open location management device 101. The location management request includes at least a user ID, and the location management condition parameters such as the required response time, the precise of positioning, the previous location information of the user. At step S702, the location information provider selecting unit 1011 in the open location management device 101 extracts the location management condition parameters from the location management request with respect to the user. At step S703, the location information provider selecting unit 1011 sets the location inquiry priority of the location information providers in the location information provider list according to the extracted parameters.

At step S704, the location information provider selecting unit 1011 puts the user ID of the user need to be located into the location inquiry request, and sends the location inquiry request to the location information providers in the order of the priority. At step S705, the location information provider selecting unit 1011 receives the location information answering messages from the location information providers. At step S706, the location information provider selecting unit 1011 detects if the location information provider returning the location information has the highest priority among all the location information providers capable of returning the location information. And if not, the process returns to step S705 and continues to receive the answering messages; if yes, the process proceeds to step S707.

At step S707, the location information notifying unit 1014 returns the location information, as the respond, to the communication network 102.

It will be appropriated for persons skilled in the art that, the location information provider having the “highest priority” means the other providers who have higher priority than this provider all return the rejection message; and this provider has the highest priority among the providers capable of returning the location information. In addition, when the location information provider selecting unit 1011 determines there is no location information provider capable of providing the location information of the user based on certain trigger, it will return a message presenting that it could not provide the location management service to the communication network to the communication network 102. The trigger, for example, is when all the location information providers return rejection message, or when the location information provider selecting unit 1001 fails to receive any confirmation information from any of the location information providers after certain time.

Furthermore, in the flowchart shown in FIG. 7, it is the communication network that provides the selection policy to the open location management device 101. It will be appropriated for persons skilled in the art that, the selection policy may be pre-stored in the open location management device 101 and used by the location information provider selecting unit 1011 to perform the selection operation.

According to the third embodiment of the invention, the system may flexibly perform the different location management corresponding to different management requirements, since the system may select a location information provider based on certain specific selection policy.

In addition, new location information providers may be added into the above described open location management device 101 when needed, and new selection policy and the corresponding selection operation thereof may also be added according to the requirement of the communication network. The system according to the invention provides an open standard framework capable of providing location management.

In addition, while FIG. 3 shows only the structure of the location information provider i, the other location information providers also have the same structure. The communication network 102 may act as a location information provider, and the location information provider may, in turn, act as a location information requestor. Their positions may exchange or combine with each other. for example, the network 102 may be both the location information requestor and the location information provider, so that it could provide the service for other location information requesters by utilizing its own location management function and sufficiently utilizes the external location management function.

It will be appropriated for persons skilled in the art that the open location management device may be combined into the communication network, i.e., the location information requestor, as an attachment. Note that the above embodiments are only used to explain the invention, but not to limit the invention.

The invention has been described by reference to the embodiments and the drawings, which are not used to limit the invention. And the invention can be modified and improved without departing the spirit and the scope of the claims.

What is claimed is:

1. An open location management device comprising:
a location information provider list for recording the IDs of at least one location information provider capable of performing location management;
location information provider selecting means for selecting one of the location information provider in said location information provider list to provide the location information of a user for the location information requester, in response to a request for performing location management with respect to the user from a location information requester;
location information notifying means for notifying said location information requester the location information of the user provided by the selected location information provider in said location information provider list; and
said location information provider selecting means selecting the location information provider based on specific selection policy.

2. An open location management device as claimed in claim 1, comprising a unique user ID is assigned to individual user of said location information requester and said location information provider.

3. An open location management device as claimed in claim 2, comprising a location management table for storing the correspondence relationship between the user ID of the user and the ID of the location information provider selected for the user.

4. An open location management device as claimed in claim 1, comprising said open location management device is a part of said location information requester.

5. A open location management device as claimed in claim 1, wherein said at least one location information provider each comprising:
location information answering means for receiving a location;
information inquiry request including said user ID included in said location management request, and for returning the result of the location information inquiry to said open location management device;
a current user list, connected to said location information answering means, for recording the terminal IDs of the users being registered in said location provider and the user IDs of the users, respectively;
location determining means, for determining the location information of the user having the user ID provided by said location information answering means, and for sending the location information back to said location information answering means.

6. An open location management method, comprising the steps of:
receiving a user location management request including a user ID from a location information requester;
sending to at least one location information provider a location information inquiry request including the user ID;
receiving the returned location information from the at least one location information provider;
selecting one location information returned from one of the at least one location information provider;
returning the selected location information to said location information requester;
characterized in that:
said selecting step further comprising the step of selecting the location information provider based on specific selection policy.

7. An open location management method as claimed in claim 6, further comprising the steps of:
said at least one location information provider each receiving said location information inquiry request including said user ID;
said at least one location information provider each detecting if said user ID being registered in the provider;
said at least one location information provider each determining the location information corresponding to said user ID and returning the same, when it detects that said user ID is registered in the provider.

8. An open location management method as claimed in claim 7. wherein said user ID is unique to each user.

9. An open location management method as claimed in claim 6, wherein said selecting step further comprising the step of storing the correspondence relationship between the user ID of the user and the ID of the location information provider selected for the user.

10. A computer program product comprising a computer usable medium having computer readable program code means embodied therein for causing open location management, the computer readable program code means in said computer program product comprising computer readable program code means for causing a computer to effect the functions of:
a location information provider list for recording the IDs of at least one location information provider capable of performing location management;
location information provider selecting means for selecting one of the location information provider in said location information provider list to provide the location information of a user for the location information requester, in response to a request for performing location management with respect to the user from a location information requester;
location information notifying means for notifying said location information requester the location information of the user provided by the selected location information provider in said location information provider list; and
said location information provider selecting means selecting the location information provider based on specific selection policy.

11. An article of manufacture comprising a computer usable medium having computer readable program code means embodied therein for causing open location management, the computer readable program code means in said article of manufacture comprising computer readable program code means for causing a computer to effect the steps of:
receiving a user location management request including a user ID from a location information requester;
sending to at least one location information provider a location information inquiry request including the user ID;
receiving the returned location information from the at least one location information provider;
selecting one location information returned from one of the at least one location information provider;
returning the selected location information to said location information requester;
characterized in that:
said selecting step further comprising the step of selecting the location information provider based on specific selection policy.

12. A program storage device readable by machine, tangibly embodying a program of instructions executable by the machine to perform method steps for open location management, said method steps comprising the steps of claim 6.

13. A program storage device readable by machine, tangibly embodying a program of instructions executable by the machine to perform method steps for open location management, said method steps comprising the steps of claim 7.

14. A program storage device readable by machine, tangibly embodying a program of instructions executable by the machine to perform method steps for open location management, said method steps comprising the steps of claim 8.

15. A program storage device readable by machine, tangibly embodying a program of instructions executable by the machine to perform method steps for open location management, said method steps comprising the steps of claim 9.

16. A computer program product comprising a computer usable medium having computer readable program code means embodied therein for causing open location management, the computer readable program code means in said computer program product comprising computer readable program code means for causing a computer to effect the functions of claim 2.

17. A computer program product comprising a computer usable medium having computer readable program code means embodied therein for causing open location management, the computer readable program code means in said computer program product comprising computer readable program code means for causing a computer to effect the functions of claim 3.

18. A computer program product comprising a computer usable medium having computer readable program code means embodied therein for causing open location management, the computer readable program code means in said computer program product comprising computer readable program code means for causing a computer to effect the functions of claim 4.

19. A computer program product comprising a computer usable medium having computer readable program code means embodied therein for causing open location management, the computer readable program code means in said computer program product comprising computer readable program code means for causing a computer to effect the functions of claim 5.

20. A computer program product comprising a computer usable medium having computer readable program code means embodied therein for causing open location management, the computer readable program code means in said computer program product comprising computer readable program code means for causing a computer to effect the functions of claim 6.
